(19) United States
(12) Patent Application Publication
(10) Pub. No.: US 2022/0388873 A1
(43) Pub. Date: Dec. 8, 2022

(54) Bottlecap with UV LED and a removable filter cartridge for water purification

(71) Applicant: Rakesh Guduru, Miramar, FL (US)

(72) Inventor: Rakesh Guduru, Miramar, FL (US)

(21) Appl. No.: 17/302,309

(22) Filed: Apr. 29, 2021

Related U.S. Application Data
(63) Continuation-in-part of application No. 16/874,552, filed on May 14, 2020, now Pat. No. 11,214,499.

(51) Int. Cl. C02F 1/32; C02F 1/00; B65D 47/06; B65D 51/24

(52) U.S. Cl. CPC C02F 1/32; C02F 1/002; B65D 47/065; B65D 51/24; C02F 2201/006; C02F 2201/3221; C02F 2201/3222; C02F 2307/02

(57) ABSTRACT

A water sanitization cap for covering a bottle is provided. The cap may include an ultraviolet-C (“UV-C”) light emitting diode (“LED”) housing and a shell. The shell may be adjacent to a portion of the housing. The cap may also include a waterproof compartment formed within the interior of the housing. The waterproof compartment may include one wall formed at least in part from a transparent material. The cap may include a UV-C LED. The UV-C LED may be fixed within the waterproof compartment, proximal to one end of the UV-C LED housing and oriented to shine light through the transparent material. The cap may include a sensor that when activated, applies a voltage to the UV-C LED to cause the UV-C LED to emit light. The cap may include a cartridge cage that can hold a cartridge. The cartridge cage may be removably attachable to an inner surface of the shell. The waterproof compartment wall may be positioned relative to the cartridge cage such that the UV-C LED, in use, treats water within the bottle before the water flows through the cartridge cage.

### FIELD OF TECHNOLOGY

This disclosure relates to water sterilization and/or modification. Specifically, this disclosure relates to water sterilization and/or modification properties using a bottle cap, such as, for example, a water sterilization cap.

### BACKGROUND OF THE DISCLOSURE

Microorganism-free, pathogen-free, virus-free and bacteria-free water is a necessity for human life. Many times, in various locations around the globe, clean, bacteria-free water is unavailable because of a variety of reasons.

Traditionally, this problem has been solved by single-use plastic water bottles. However, as a result, plastic waste from single-use plastic water bottles has grown exponentially. The plastic waste generated by disposed-of single-use plastic water bottles has generated a waste-management problem. Additionally, single-use plastic water bottles may be costly, especially in various locations around the globe.

Therefore, it is desirable to provide an apparatus for sterilizing and/or purifying water retrieved from bio-contaminated sources or sources of unknown contamination levels.

It is further desirable for the apparatus to operate together with typical reusable bottles.

It is yet further desirable for the apparatus to operate as a cap for typical reusable bottles.

### SUMMARY OF THE DISCLOSURE

Aspects of the disclosure include sanitizing, flavoring and/or modifying water using both ultraviolet C (“UV-C”) rays and a modular cartridge. The modular cartridge may include a filter cartridge, pH modifying cartridge and/or taste enhancing and/or modifying cartridge.

The water may be contained within a conventional reusable bottle. A cap may cover the reusable water bottle.

The cap may include a UV-C module. The UV-C module may shine UV-C rays into the water within the water bottle. The UV-C module may destroy harmful bacteria and viruses within the water. The cap may include a second UV-C LED module. The second UV-C module may operate at the same time as the first UV-C LED module, may operate alternatively with the first UV-C LED module and may operate upon failure of the first UV-C LED module and/or any other suitable time.

The cap may also include a cartridge cage. The cartridge cage may hold a cartridge. The cartridge may be disposable. The cartridge and/or cartridge cage may be shaped in a half-circle and/or half ring shape. The cartridge cage may be removably attachable to the inner surface of the shell

The cartridge may be a particulate filter. The cartridge may include a particulate filter. The particulate filter may filter water from particulate matter, such as soil, clay, plant debris, animals, biofilms, limescale and any other suitable particulate matter. The particulate filter may also filter water from chemicals, such as nitrogen, bleach, chlorine, fluoride, metals, salts, lead, chloride and any other suitable chemicals.

The particulate filter may be specific to a certain particulate matter. For example, one particulate filter may effectively remove lead from the water, while another particulate filter may effectively remove chloride from the water. Yet another particulate filter may be a universal filter that removes a variety of particulate matter.

The cartridge may be a pH modification cartridge. The cartridge may include pH modification material. The pH modification material may change the pH of the liquid, or water, as it passes through the cartridge.

The cartridge may be a flavor-enhancing and/or flavor-modifying cartridge. The cartridge may include flavor-enhancing or flavor-modifying material. The flavor-enhancing material may infuse flavor into the water when the water passes through the cartridge.

In some embodiments, the cartridge cage may be filled with fruit, such as strawberries, raspberries, lemon, coffee or other flavor-enhancing material. The fruit or other flavor-enhancing material may infuse flavor into the water when the water passes through the cartridge cage. The cartridge cage may be washable to enable the removal of used fruit and insertion of new fruit.

The cartridge may be a carbonation-adding cartridge. As such, a carbonation-adding cartridge may carbonate to the water within a bottle attached to cap. The carbonation-adding cartridge may also carbonate water as it passes through the cartridge.

The cap may include a UV-C LED housing. The cap may also include a shell. The shell may surround at least a portion of the UV-C LED housing. The UV-C LED housing may be adjacent to the cartridge cage.

The cap may include a cavity for a foldup straw. The cavity may include at least three walls and a floor.

The cap may include a waterproof compartment formed within the interior of the UV-C LED housing. The waterproof compartment may include one wall formed at least in part from a transparent material. The waterproof compartment may include an exterior surface including an end wall. The one wall may be the end wall.

The UV-C LED may be fixed within the waterproof compartment. The UV-C LED may be oriented to shine light through the transparent material.

The cap may include a sensor. The sensor, when activated may apply a voltage to the UV-C LED to cause the UV-C LED to emit light.

The cartridge cage may be removably attachable to the inner surface of the shell. The waterproof compartment end wall may be positioned relative to the cartridge cage such the UV-C LED, in use, treats water within the bottle before the water flows through the cartridge cage.

The cap may include a foldup straw. The foldup straw may be maintained in either an upright state or in a horizontal state.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative top-down perspective view of a cap screwed into a bottle in accordance with embodiments of the disclosure; the top-down perspective view shows a foldaway straw in an open position;

FIG. 2 shows an illustrative side view of a cap screwed into a bottle in accordance with embodiments of the disclosure; the side view shows a foldaway straw in an open position;

FIG. 3 shows another illustrative side view of a cap screwed into a bottle in accordance with embodiments of the disclosure; the side view shows a foldaway straw in an open position;

FIG. 4 shows still another illustrative side view of a cap screwed into a bottle in accordance with embodiments of the disclosure; the side view shows a foldaway straw in an open position;

FIG. 5 shows yet another illustrative side view of a cap screwed into a bottle in accordance with embodiments of the disclosure; the side view shows a foldaway straw in an open position;

FIG. 6 shows an illustrative top view of a cap in accordance with embodiments of the disclosure; the top view shows a foldaway straw in an open position;

FIG. 7 shows an illustrative bottom view of a cap in accordance with embodiments of the disclosure; the bottom view shows a foldaway straw in an open position;

FIG. 8 shows an illustrative top-down perspective view of a cap screwed into a bottle in accordance with embodiments of the disclosure; the top-down perspective view shows a foldaway straw in a closed position;

FIG. 9 shows an illustrative bottom perspective view of a cap in accordance with embodiments of the disclosure;

FIG. 10 shows an illustrative top perspective view of a cap in accordance with embodiments of the disclosure; the top perspective view shows a foldaway straw in an open position;

FIG. 11 shows another illustrative top perspective view of a cap in accordance with embodiments of the disclosure; the top perspective view shows a foldaway straw in an open position;

FIG. 12 shows an illustrative perspective view of a cartridge cage;

FIG. 13 shows another illustrative perspective view of a cartridge cage;

FIG. 14 shows an illustrative perspective view of a cartridge; and

FIG. 15 shows another illustrative perspective view of a cartridge.

### DETAILED DESCRIPTION OF THE DISCLOSURE

A water sanitization cap for covering a bottle is provided. The water sanitization cap may include a barrel. The water sanitization cap may also include a shell. The shell may surround at least a portion of the barrel. The shell may have an outer surface and an inner surface.

The cap may also include a waterproof compartment. The waterproof compartment may be formed within the interior of the barrel. The waterproof compartment may include at least one wall. The at least one wall may be formed at least in part from a transparent material. The transparent material may be quartz crystal.

Quartz crystal may be a material that enables UV-C rays to go through it. Any suitable material that allows passage of UV-C rays may be utilized to form a portion of a wall of the waterproof compartment. Such a material may include a flexible silicone material that enables the penetration of UV-C rays.

The cap may also include a light emitting diode (“LED”). The LED may be fixed within the waterproof compartment. The LED may be proximal to one end of the barrel. The LED may be oriented to shine light through the transparent material.

The light emitted from the LED may be ultraviolet (“UV”) light ranging between 100 and 400 nm. As such, the LED may be a UV-C LED. A UV-C LED may produce UV-C light, also referred to herein as UV-C rays. UV-C light may be short-wave UV rays in the range of 100-280 nanometers. In some embodiments, the light emitted from the UV-C LED may preferably be about 278 nm.

UV-C rays may penetrate liquids. UV-C rays may penetrate translucent, or partially translucent liquids. UV-C rays may penetrate microbial cells included in liquids and/or translucent liquids. UV-C rays may destroy the active core (nucleic acids) of the microbial cells. The microbial cells may no longer be viable without the active core. After a period of time, the non-active microbial cells may revert to fundamental constituents, such as carbon dioxide (CO₂), and trace elements, such as N (Nitrogen), P (Phosphorus), O (Oxygen) and S (Sulfur).

It should be appreciated that the UV-C rays may be produced, by the LED, without the use of toxic mercury. Toxic mercury may be harmful if ingested.

In some embodiments, the cap may include a safety feature to prevent damage from UV-C rays. The safety feature may guard an unprotected eye or skin which may be damaged by UV-C rays. The safety feature may restrict the UV-C LED from being activated unless the cap is secured onto a bottle. The safety feature may include one, two or more pins included in an inner surface of the shell. The one, two or more pins may restrict the UV-C LED from activating unless the pins are depressed. The pins may not be depressed when the cap is detached from a bottle. The pins may be depressed when the cap is screwed onto, or otherwise secured to a bottle.

The cap may also include a sensor. When activated, the sensor may apply a voltage to the LED to cause the LED to emit light.

In some embodiments, sensor may be a touch sensor. The touch sensor may respond to a single touch, double touch, multi-touch or any other suitable predetermined touch pattern. A single touch may initiate the display of the remaining battery charge.

A double touch may initiate activation of the UV-C LED for a first predetermined period of time. The first predetermined period of time may be 30 seconds, 60 seconds, 90 seconds or any other suitable period of time. Exposure of the contents of the bottle to the UV-C LED rays for the first predetermined period of time may be suitable for destroying microbial cells found in liquids from mildly to moderately contaminated sources. Such mildly to moderately contaminated sources may include unfiltered tap water and water from fountains. Exposure of a UV-C LED to a six to one hundred-and twenty-eight-ounce bottle for the first predetermined time period may sterilize the contents of the bottle to 99.99%.

A multi-touch, such as a three, four, five, six or other suitable number of touches, may initiate activation of the UV-C LED for a second predetermined period of time. The second predetermined time period may be 90 seconds, 120 second, 150 seconds, 240 seconds, 360 seconds or any other suitable time period. Exposure of the contents of the bottle to the UV-C LED rays for the second predetermined period of time may be suitable for destroying microbial cells found in liquids from moderately to highly contaminated sources. Such moderately to highly contaminated sources may include water from lakes and ponds. Exposure of a UV-C LED to a 6-128-ounce bottle for the second predetermined time period may sterilize the contents of the bottle to 99.9999%.

The cap may also include a cartridge cage. The filter cage may be operable to hold a cartridge. The cartridge may be a filter cartridge, pH modification cartridge, flavor-enhancing cartridge, any other suitable cartridge or a cartridge that includes one or more of the above-mentioned capabilities. It should be appreciated that the cartridge cage and/or the cartridge may be replaceable. The cartridge cage may include a cartridge cage threaded section.

The water sanitization cap may include a charging site. The charging site may be integral to the shell.

The cap may include a charging site. The charging site may be integral to the shell. As such, a portion of the shell may form the charging site. The charging site may charge a battery located within the cap.

It should be appreciated that the charging site may, in some embodiments, not include a charging port, or at least a readily discernable charging port. Examples of a readily discernable charging port may include a universal serial bus (“USB”) port or micro-USB port. For the purposes of this application, port-less may be understood to mean no readily discernable location for the uptake of charging power.

It should be further appreciated that even though the charging site may be port-less, the charging site may utilize a wired connection. In these embodiments, the shell itself may include at least two areas that may conduct electricity. The two areas may be constructed of metal. The first area may be a positive area. The positive area may act a positive charging pole. The second area may be a negative, or ground, area. The negative area may act as a negative charging pole. The positive area and the negative area may be in any suitable shape. An example of a shape may be a ring shape or concentric circle shape. An insulation area may insulate the positive area from the negative area. The insulation area may also be any suitable shape. An example of a suitable shape may be a ring shape. The insulation area may be constructed from an insulating material, such as plastic.

A charger may be used to charge the cap. The charger may be constructed to fit over the shell of the cap. The charger may include a charging terminal. The charging terminal may be built into the inner shell of the charger. The charging terminal may include positive and negative pins. The positive pin may be operable to contact the positive area on the cap. The negative pin may be operable to contact the negative area on the cap. When the charger is fit over the shell, the positive and negative pins may come in contact with the conductive material of the shell of the cap. Once in contact with the positive and negative areas on the cap, the positive and negative pins may charge the battery within the cap. It should be appreciated that the charger may be connected, using a wired connection, or a wireless connection, to a device that provides power. Such a device may include a laptop, electric outlet or any other suitable device.

There may be multiple embodiments for removably and/or fixedly attaching the cartridge cage to the cap. One embodiment may include a snap design in which the cartridge cage snaps into the cap. Another embodiment may include a spring-loaded push design in which the cartridge cage is pushed into the cap.

Yet another embodiment may include a threaded design. There may be multiple embodiments for screwing the cartridge cage into the cap. A first embodiment may include a cartridge cage threaded section on the cartridge cage. The cartridge cage threaded section may be located on the upper outer surface of the cartridge cage. The cartridge cage threaded section on the outer upper surface of the cartridge cage may screw into a shell threaded section on the inner surface of the shell. As such, the cartridge cage threaded section and the shell threaded section may be complimentary to one another.

A second embodiment may include a cartridge cage threaded section on the cartridge cage. The cartridge cage threaded section may be located on the upper inner surface of the cartridge cage. The cartridge cage threaded section on the upper inner surface of the cartridge cage may screw into a barrel threaded section on an upper outer surface of the barrel. The upper outer surface of barrel may be the surface on the external portion of the barrel on the side that furthest from the UV-C LED. As such, the cartridge cage threaded section and the barrel threaded section may be complimentary to one another.

In some embodiments, the barrel may be, in whole, or in part, constructed from plastic. When the UV-C rays are emitted from the LED, micro-cracks may form in the portion of the barrel that is exposed to the light. Therefore, a shield, which may be constructed from a metallic material, such as stainless-steel, may protect the portion of the barrel from being exposed to the UV-C rays. In this way, the barrel is not exposed to, and possibly damaged by, the UV-C rays.

As such, the cap may include a shield. The shield may be stainless-steel. The shield may be constructed from any suitable metallic material. The shield may be constructed from any other suitable material. The shield may be operable to shield the barrel from light generated by the LED.

Additionally, at least a portion of the construction of the cap may be a pressure-fit construction—i.e., the components within the cap may be pressure-fit to one another. For example, the shield may be pressure-fit to the barrel and the barrel may be pressure-fit to the shell. The pressure-fitting may be important because the construction may preferably not include glue. Glue may be undesirable because glue may degrade, and, as the glue degrades, it may leach into the water included in the bottle.

A foldaway straw may be constructed as part of the shell. The foldaway straw may be maintained in either an upright state or in a horizontal state. When the foldaway straw is in the horizontal state, the foldaway straw may partially or completely form a plane that is perpendicular to a longitudinal axis of the bottle.

A flow pipe may connect the foldaway straw, in an upright state, to an annular space between the cartridge cage and the barrel or other suitable location. The flow pipe may directly enable water, under suction, to pass from the flow pipe into the foldaway straw. The flow pipe may indirectly enable water, under suction, to pass from the annular space into the flow pipe.

The shell may also include a cavity. The cavity may store the foldaway straw when the foldaway straw is in the horizontal state. The sensor may fit into the cavity. The sensor may be accessible when the foldaway straw is in the upright state. As such, the sensor may be child resistant because the sensor may be inaccessible when the foldaway straw is in a horizontal position.

The cap may include one or more other sensors. The one or more other sensors may be operable to measure water depth and/or water temperature. The one or more other sensors may be ultrasonic. The one or more sensors may be built-in probes, such as temperature probes. In some embodiments, the one or more other sensors may constantly remain active. In certain embodiments, the one or more other sensors may determine water data after a predetermined period of time has lapsed. The predetermined period of time may be thirty seconds, one minute, five minutes, thirty minutes or any other suitable time period. In other embodiments, the sensor may determine water data each time the cap is replaced on the bottle. The one or more sensors may be also be known as a hydration meter, as it measures the user's hydration.

Smart logic programming along with sensor calibration may enable the detection of false readings to avoid anomalies. For example, the sensor may determine when the cap is not placed on the bottle. Also, the sensor may determine when the level of the contents is not static, such as during transportation.

The cap may also include a transceiver. The transceiver may transmit and/or receive data from an associated device. The device may be a smartphone, computer, tablet or other suitable device. The transceiver may connect to the device using Bluetooth®, Wi-Fi, or any other suitable communication protocol. The transceiver may transmit water depth, water temperature and/or water sterilization status data to the device. The device may use the received water depth, water temperature and/or water sterilization status data to determine a user's total water consumption.

The device may include an application. The application may receive the water depth, water temperature and/or water sterilization status data. The application may combine the received water depth, water temperature and/or water sterilization status data with timestamp and/or geotagging data determined by the application. The combined data may enable the application to determine water consumption over a period of time, a specific time period and/or a day. The combined data, specifically the geotagging data may help calculate the water consumption when traveling or water consumption at a specific location. The application, based on the data, may instruct a user regarding hydration. Such instruction may include instructing a user to drink more water during specific times during the day and/or at specific locations. Such instruction may display to a user to the difference between water consumption at various geographic locations. For example, such instruction may display to a user the difference between water consumption at home and water consumption at an office location.

In some embodiments, the water sanitization cap may be used to sanitize surfaces, such as a keyboard, mouse, tablet, etc. In such embodiments, the cap may be waved within a predetermined proximity of the surface, e.g., one inch, two inches, three inches of four inches. The waving may be executed for a predetermined amount of time such as one minute or two minutes.

Apparatus described herein are illustrative. Apparatus in accordance with this disclosure will now be described in connection with the figures, which form a part hereof. The figures show illustrative features of apparatus in accordance with the principles of this disclosure. It is to be understood that other embodiments may be utilized and that structural, functional and procedural modifications may be made without departing from the scope and spirit of the present disclosure.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

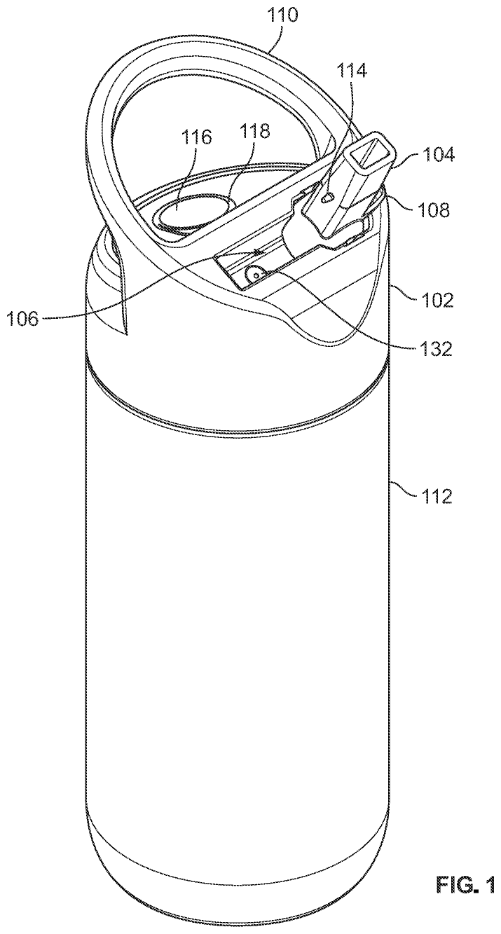

FIG. 1 shows an illustrative top-down perspective view of an exemplary hybrid sterilization cap. The exemplary sterilization cap is shown, in FIG. 1, screwed into bottle 112. The hybrid sterilization cap may combine content/bottle sterilization via UV light and particulate filtering, chemical filtering, pH modifying and flavor-enhancing via a preferably modular cartridge cage that holds a modular replaceable cartridge.

The hybrid sterilization cap may include multiple components. Table A includes an exemplary list of components that may be included in the hybrid sterilization cap. It should be appreciated that more components or less components than those included in table A may be included in the hybrid sterilization cap.

TABLE A

| | |
|---|---|
| top portion of cap/shell | 102 |
| foldaway straw | 104 |
| cavity to store foldaway straw | 106 |
| finger tab on foldaway straw | 108 |
| handle | 110 |
| bottle | 112 |
| plug on foldaway straw to stop vent hole | 114 |
| button/touch sensor | 116 |
| LED ring around button/touch sensor | 118 |
| portless charging site | 120 |
| quartz crystal | 122 |
| quartz crystal (2) | 124 |
| UV-C LED | 126 |
| UV-C LED (2) | 128 |
| cartridge cage | 130 |
| vent hole | 132 |
| threads to on inner portion of shell to screw cap into bottle | 134 |
| UV-C LED housing | 136 |
| aperture on cartridge cage to connect to foldaway straw | 138 |
| shield | 140 |
| shield (2) | 142 |
| cartridge | 144 |

One component included in the hybrid sterilization cap may be a top portion of the cap. The top portion of the cap may also be referred to herein as shell 102. Another component may be a UV-LED housing, also referred to herein, as an alternative, as a barrel (not shown in FIG. 1). Shell 102 may encapsulate all or a portion of the UV-LED housing.

The sterilization cap may be constructed from metallic materials, stainless steel materials, glass materials, quartz glass materials, silicon materials, silicone materials, plastic materials and/or any other suitable materials or a combination thereof. In some embodiments, at least a portion of shell 102 may be constructed from plastic materials. In certain embodiments, the UV-C LED housing may be constructed at least partially from plastic materials.

The sterilization cap may include threads on the inner portion of shell 102. The threads on the inner portion of shell 102 to screw cap into bottle are shown at 134 (obscured from view in FIG. 1). The threads on the inner portion of shell 102 may screw into bottle 112.

Bottle 112 may be constructed from metallic materials, glass materials, plastic materials, insulating materials or any other suitable materials. Bottle 112 may insulate its contents in order to maintain a temperature of the bottle contents within a predetermined range for more than a predetermined amount of time.

The sterilization cap may also include a foldaway straw 104. Foldaway straw 104 may be positioned in an open state or in a closed state. In an open state, foldaway straw 104 may be deployed for use. As such, when the foldaway straw is in an open state, a user may suck through foldaway straw 104 to obtain the contents of bottle 112. In a closed state, foldaway straw 104 may be undeployed. As such, in a closed state, foldaway straw 104 may be folded into cavity 106 formed by a hollow in shell 102.

Vent hole 132 may enable venting so that the water can pass up through the straw. Vent hole 132 may be blocked by foldaway straw 104 and be plugged by plug 114 when foldaway straw 104 is in an undeployed state. It should be appreciated that opening foldaway straw 104 may open an air lock and create a vent via vent hole 132. Closing foldaway straw 104 is preferably designed to close vent hole 132.

Finger tab 108 may enable a user to push foldaway straw from an open position to a closed position. Finger tab 108 may also enable a user to pull foldaway straw from a closed position to an open position.

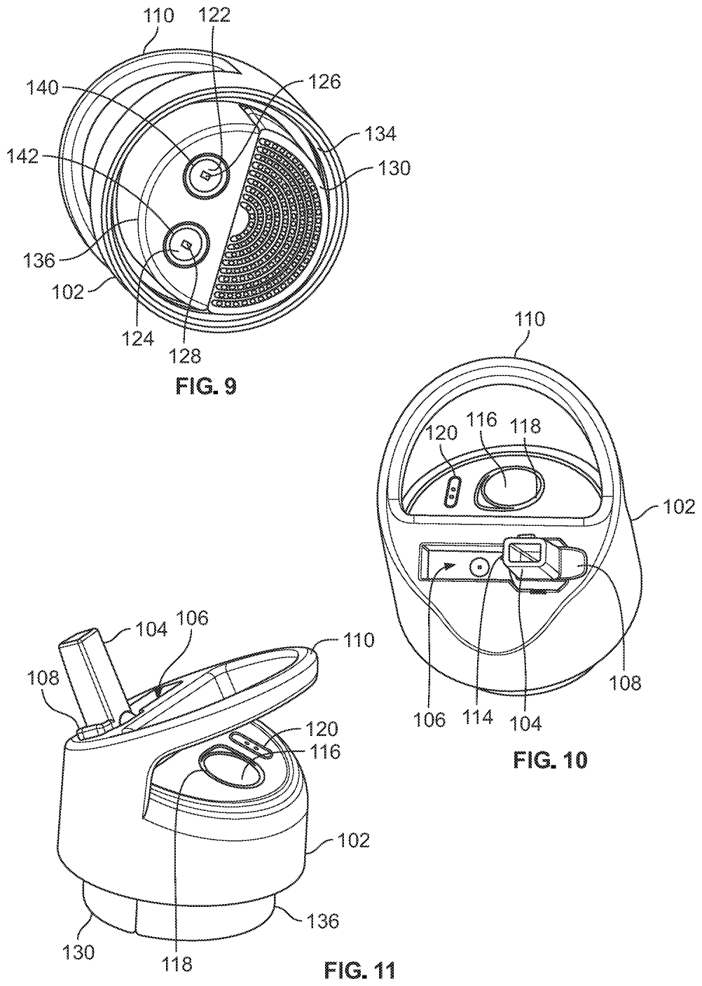

Button/touch sensor 116 may be used to activate a UV-C LED (labeled 126 and 128, not shown in FIG. 1, but shown for example, in FIG. 9). Ring 118 may surround button/touch sensor 116. Ring 118 may be an LED ring. Ring 118 may illuminate to indicate the UV-C LED status, the battery status and/or any other suitable reason. For example, if the UV-C LED is activated, ring 118 may illuminate a predetermined color.

The hybrid sterilization cap may also include handle 110. Handle 110 may enable a user to hold bottle 112.

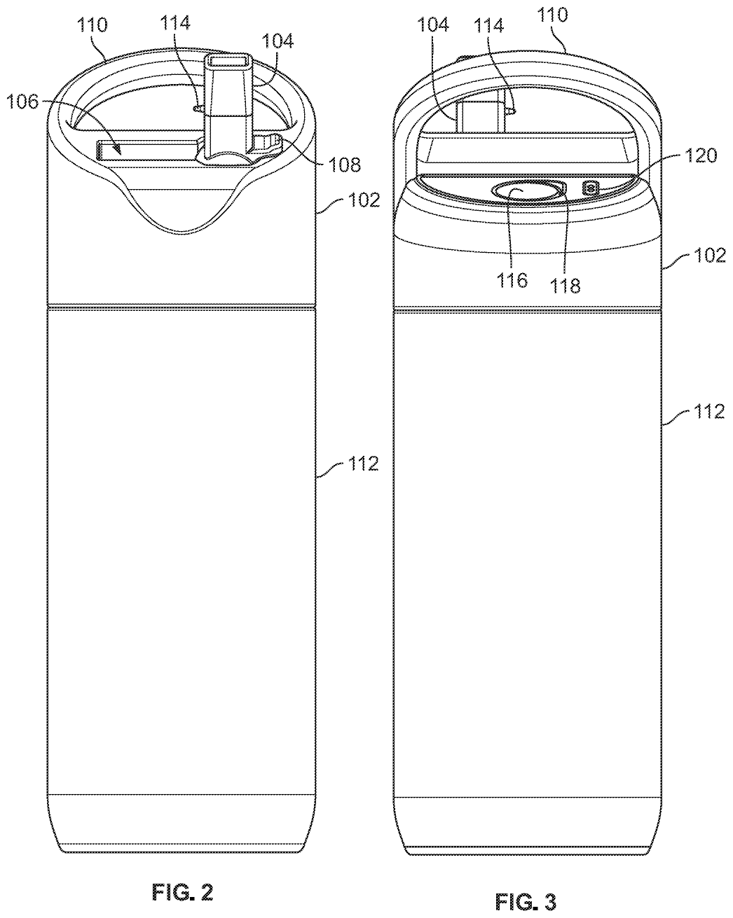

FIG. 2 shows a side view of a sterilization cap screwed into bottle 112.

FIG. 3 shows another side view of a sterilization cap screwed into bottle 112. The sterilization cap may also include portless charging site 120. A charging cord may attach to portless charging site 120 and to a charging source such as an outlet. It should be appreciated that the charging cord may attach to portless charging site 120 using magnetic attraction. The portless charging site may provide power to a rechargeable battery included in the sterilization cap.

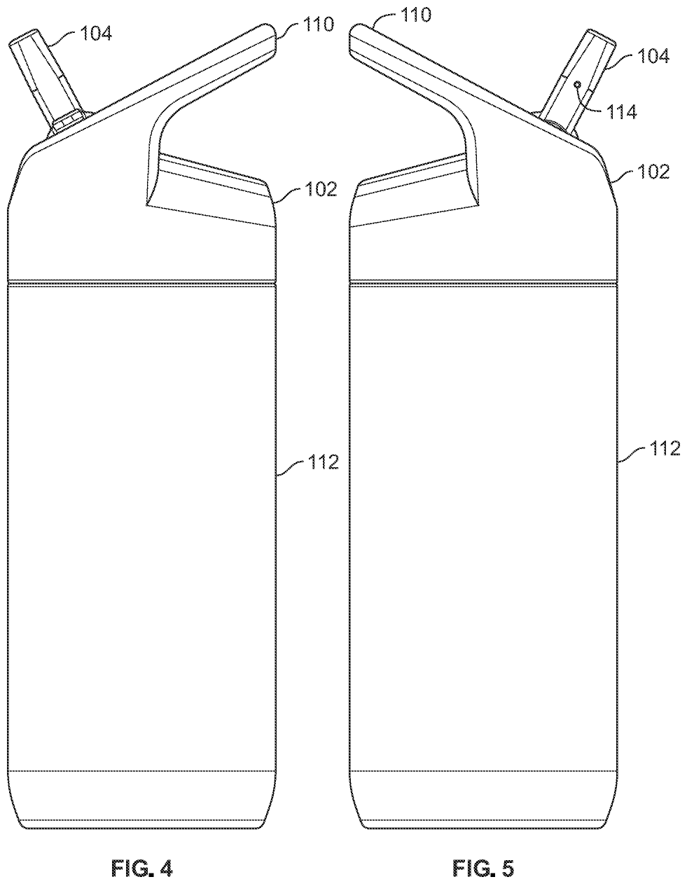

FIG. 4 shows yet another side view of the sterilization cap and bottle 112.

FIG. 5 shows still another side view of the sterilization cap and bottle 112.

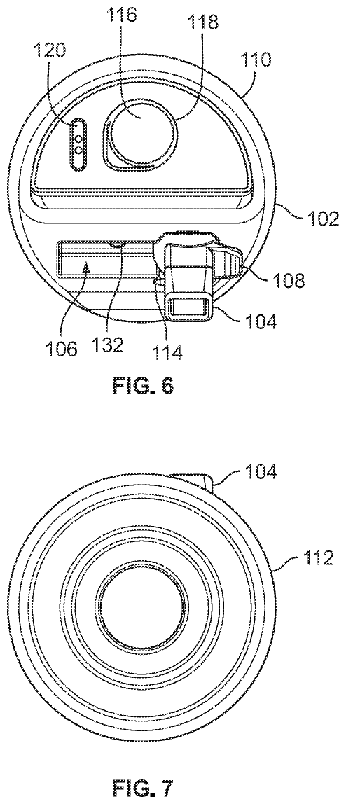

FIG. 6 shows a top view of the sterilization cap.

FIG. 7 shows a bottom view of the sterilization cap. Foldaway straw 104 may be viewable from the bottom when in an open state. However, foldaway straw 104 may not be viewable in a bottom view when the foldaway straw is in a closed state.

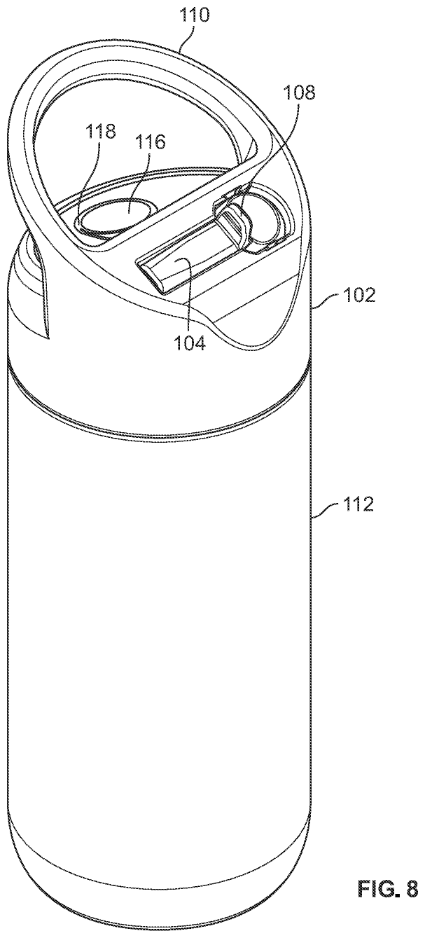

FIG. 8 shows an illustrative top-down perspective view of an exemplary hybrid sterilization cap screwed into bottle 112. In FIG. 8, foldaway straw 104 is shown in a closed state.

FIG. 9 shows an illustrative bottom perspective view an exemplary sterilization cap. The sterilization cap may screw into bottle 112 (not shown) using threads 134 on the sterilization cap. The sterilization cap may include cartridge cage 130. Cartridge cage 130 may be operable to hold a cartridge. The cartridge may be a filter cartridge, a pH modifying cartridge and/or a taste enhancing and/or modifying cartridge.

The sterilization cap may also include a UV-LED housing 136. UV-C LED housing 136 may provide a waterproof compartment for one or more UV-C LEDs. UV-C LED 126 and UV-C LED 128 may be encased in UV-C LED housing 126. Quartz crystals 122 and 124 may be formed from a transparent material that enables transmission therethrough by UV-C LED rays. As such, quartz crystals 122 and 124 may provide a transparency through which UV-C LEDs 126 and 128 may penetrate the contents of the bottle. The UV-C LEDs may remain in the waterproof compartment of the UV-C LED housing and be able to transmit UV-C rays into the contents of bottle 112.

After the contents of the bottle has been sterilized by UV-C LED 126 and/or UV-C LED 128. The water may in condition for further filtration and subsequent drinking. The water may enter cartridge cage 130 and be sucked into foldaway straw 104 when foldaway straw 104 is in an open position.

It should be appreciated that, at times, both UV-C LEDs may operate in tandem. At other times, a first UV-C LED may operate and, when the first UV-C LED fails, the second UV-C LED may operate. Yet other times, the first UV-C LED and second UV-C LED may operate alternatively—i.e., the first UV-C LED may operate for a time period and then the second UV-C LED may operate for a second time period.

It should be further appreciated that the UV-C LEDs may be shown at the bottom of the UV-C housing. Other suitable placements of one or more UV-C LEDs may also be possible to the extent that these other placements enable the UV-C LED to be used to sterilize water in the bottle.

When the UV-C rays are emitted from the UV-C LEDs, these rays may over time cause micro-cracks to form in the plastic that is exposed to the UV-C rays. Shields 140 and 142, which may be constructed from a metallic material, such as stainless-steel, may protect the portion of the UV-C LED housing from being exposed to the UV-C rays. In this way, the UV-C housing and the cartridge cage are not exposed to, and possibly damaged by, the UV-C rays. In some embodiments, shields 140 and 142 may be constructed from a single piece of material.

It should be appreciated that the shield may be constructed from one or more portions. The shield portions may be constructed from any suitable material that protects the UV-C LED housing (and the cartridge cage) from the UV-C LED rays. A first portion of the shield may be constructed from plastic, silicon, silicone, stainless steel or any other suitable material. A second portion may be constructed from plastic, silicon, silicone, stainless steel or any other suitable material. In preferred embodiments, the first portion may be constructed from plastic, silicon and/or silicone and the second portion may be constructed from stainless steel. In FIG. 9, a segment of the first portion may be visible, however, the complete first portion and/or the second portion may not be visible.

FIG. 10 shows an illustrative top perspective view of an exemplary sterilization cap. In FIG. 10, foldaway straw 104 is shown in an open state.

FIG. 11 shows an illustrative side perspective view of an exemplary sterilization cap. In FIG. 11, UV-C LED housing 136 and cartridge cage 130 are shown adjacent to one another.

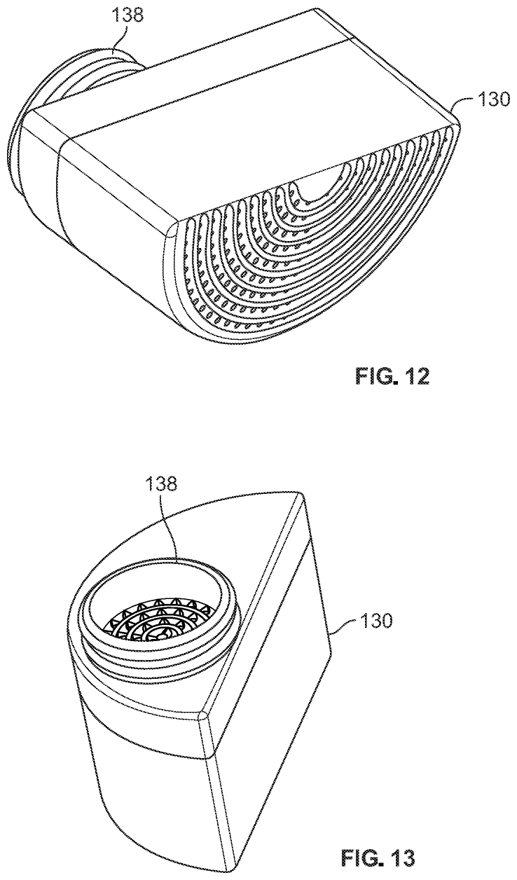

FIG. 12 shows an illustrative perspective view of a cartridge cage. Cartridge cage 130 may include aperture 138. Aperture 138 may enable water to pass through the top of cartridge cage 130 and into foldaway straw 104 (not shown). Cartridge cage 138 may be operable to hold a cartridge. Cartridge cage 138 may be opened and a cartridge may be placed into the cartridge cage 138. The ribbed wall around Aperture 128 may also enable cartridge cage 130 to be attached to top portion of cap/shell 102. The attachment may include cartridge cage 130 being pushed into, snapped into and/or in the alternative, any other suitable attachment mechanism to top portion cap/shell 102.

FIG. 13 shows another illustrative perspective view of a cartridge cage. Cartridge cage 130 may include aperture 138. Aperture 138 may enable the flow of water that has been conditioned by a cartridge, included in cartridge cage 130, into foldaway straw 104.

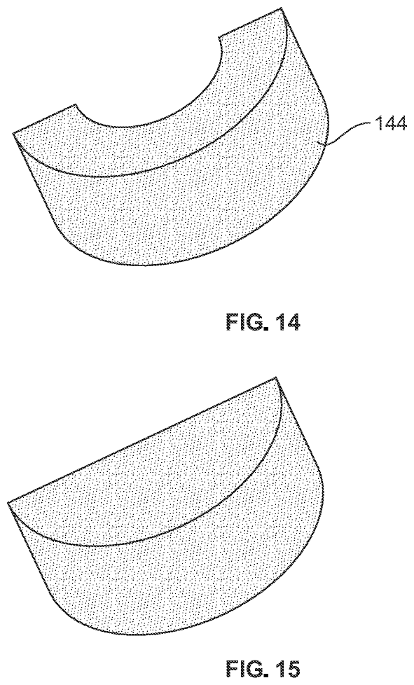

FIG. 14 shows an illustrative perspective view of a cartridge. Cartridge 144 may be shaped in a half ring shape in order to fit into the cartridge cage (not shown in FIG. 14)

FIG. 15 shows another illustrative perspective view of a cartridge. Cartridge 144 may be shaped in a half circle shape in order to fit into the cartridge cage (not shown in FIG. 15)

Thus, a sterilization cap with a removable cartridge is provided. Persons skilled in the art will appreciate that the present invention can be practiced by other than the described embodiments, which are presented for purposes of illustration rather than of limitation. The present invention is limited only by the claims that follow.

What is claimed is:

1. A water sanitization cap for covering a bottle, said cap comprising:
an ultraviolet-C (“UV-C”) light emitting diode (“LED”) housing;
a shell, said shell surrounding at least a portion of said UV-C LED housing, said shell comprising:
a shell inner surface; and
a foldup straw;
a waterproof compartment formed within the interior of the UV-C LED housing, said waterproof compartment comprising one wall formed at least in part from a transparent material;
a UV-C LED, said UV-C LED:
fixed within the waterproof compartment; and
oriented to shine light through the transparent material;
a sensor, said sensor that, when activated, applies a voltage to the UV-C LED to cause the UV-C LED to emit light;
a cartridge cage operable to hold a cartridge, said cartridge cage removably attachable to the inner surface of the shell; and
the foldup straw, the foldup straw is maintained in either an upright state or in a horizontal state.

2. The water sanitization cap of claim 1, further comprising one or more pins included in the inner surface of the shell.

3. The water sanitization cap of claim 2, wherein the one or more pins may restrict the UV-C LED from activating unless the pins are depressed.

4. The water sanitization cap of claim 3, further comprising a flow pipe, said flow pipe connecting the foldup straw, in the upright state, to an aperture of the cartridge cage, said flow pipe forming a fluid pathway from the annular space to the foldup straw.

5. The water sanitization cap of claim 4, further comprising a vent hole, said vent hole creating a vent that provides a pathway between an outer surface of the shell and the inner surface of the shell when the foldup straw is in an upright state, said vent hole being blocked when the foldup straw is in a horizontal state.

6. The water sanitization cap of claim 5, wherein a width of the vent hole is between 0.5 mm and 5 mm and the length of the vent pathway is between 0.5 mm and 1 cm.

7. The water sanitization cap of claim 7, further comprising a gasket, said gasket being shaped to fit over the track for the vent hole such that the gasket maintains a viability of the vent hole.

8. A water sanitization cap for covering a bottle, said cap comprising:
an ultraviolet-C light emitting diode (“UV-C LED”) housing;
a shell, said shell surrounding at least a portion of said UV-C LED housing;
a waterproof compartment formed within the interior of the UV-C LED housing, said waterproof compartment comprising an exterior surface including an end wall, said end wall formed at least in part from a transparent material;
an ultraviolet-C light emitting diode (“UV-C LED”), said UV-C LED:
fixed within the waterproof compartment;
proximal to one end of the UV-C LED housing; and
oriented to shine light through the transparent material;
a sensor, said sensor that, when activated, applies a voltage to the UV-C LED to cause the UV-C LED to emit light; and
a cartridge cage operable to contain a cartridge, said cartridge cage removably attachable to the inner surface of the shell, wherein the waterproof compartment end wall is positioned relative to the cartridge cage such that the UV-C LED, in use, treats water within the bottle before the water flows through the cartridge cage.

9. The water sanitization cap of claim 8, further comprising one or more pins included in an inner surface of the shell.

10. The water sanitization cap of claim 9, wherein the one or more pins may restrict the UV-C LED from activating unless the pins are depressed.

11. The water sanitization cap of claim 8, wherein the cartridge comprises particulate filtering material, chemical filtering material, pH modifying material and/or flavor-enhancing material.

12. The water sanitization cap of claim 8, further comprising a stainless-steel shield, said stainless-steel shield shielding the barrel from light generated by the UV-C LED.

13. The water sanitization cap of claim 8, wherein the UV-C LED is a first UV-C LED, the water sanitization cap further comprising a second UV-C LED, said second UV-C LED:
fixed within the waterproof compartment;
proximal to the one end of the UV-C LED housing; and
oriented to shine light through the transparent material.

14. The water sanitization cap of claim 13, wherein the transparent material is divided into two segments, a first segment and a second segment, the first UV-C LED is oriented to shine light through the first segment and the second UV-C LED is oriented to shine light through the second UV-C LED.

15. The water sanitization cap of claim 13, wherein the sensor, when activated, applies a voltage to the second UV-C LED to cause the second UV-C LED to emit light.

16. The water sanitization cap of claim 13, wherein the sensor, when activated, applies a voltage to the second UV-C LED even when the first UV-C LED is inactive. Second UV-C LED serving dual function, first to enhance the sterilization efficacy, and second as a fail-safe mechanism if first UV-C LED fails to activate.

17. The water sanitization cap of claim 8, wherein:
the shell further comprises a foldup straw;
the foldup straw is maintained in either an upright state or in a horizontal state, said foldup straw that, when in said horizontal state, at least partially forms a plane that is perpendicular to a longitudinal axis of the bottle.

18. The water sanitization cap of claim 17, further comprising:
a flow pipe, said flow pipe that connects the foldup straw, in the upright state, to the cartridge cage and the barrel, said flow pipe that forms a fluid pathway from the cartridge cage to the foldup straw; and
a vent hole, said vent hole creating a vent that provides a pathway between the outer surface of the shell and the inner surface of the shell when the foldup straw is in an upright state, said vent hole being blocked when the foldup straw is in a horizontal state.

19. A water sanitization cap for covering a bottle, said cap comprising:
an ultraviolet-C (“UV-C”) light emitting diode (“LED”) housing;
a shell, said shell adjacent to at least a portion of said UV-C LED housing;
a waterproof compartment formed within an interior of the UV-C LED housing, said waterproof compartment comprising one wall formed at least in part from a transparent material;
a UV-C LED, said UV-C LED:
fixed within the waterproof compartment;
proximal to one end of the UV-C LED housing; and
oriented to shine light through the transparent material;
a sensor, said sensor that, when activated, applies a voltage to the UV-C LED to cause the UV-C LED to emit light; and
a cartridge cage operable to contain a cartridge, said cartridge cage being removably attachable to an inner surface of the shell, wherein the waterproof compartment wall is positioned relative to the cartridge cage such that the UV-C LED, in use, treats water within the bottle before the water flows through the cartridge cage.

20. The water sanitization cap of claim 19, wherein the UV-C LED is a first UV-C LED, the water sanitization cap further comprising a second UV-C LED, the second UV-C LED is operable to:
fixed within the waterproof compartment;
proximal to the one end of the UV-C LED housing; and
oriented to shine light through the transparent material.
